(19) United States
(12) Patent Application Publication
(10) Pub. No.: US 2002/0063096 A1
(43) Pub. Date: May 30, 2002

(54) Filter cartridge and filtration method using the same

(75) Inventor: Sumio Ohtani, Kanagawa (JP)

Correspondence Address: SUGHRUE, MION,ZINN, MACPEAK & SEAS, PLLC, 2100 Pennsylvania Avenue, N.W., Washington, DC, 20037, US

(73) Assignee: FUJI PHOTO FILM CO., LTD.

(21) Appl. No.: 09/993,506

(22) Filed: Nov. 27, 2001

(30) Foreign Application Priority Data
Nov. 29, 2000 (JP) P.2000-363091

(51) Int. Cl. B01D 61/14; B01D 39/14

(52) U.S. Cl. 210/650; 210/500.41

(57) ABSTRACT

A filter cartridge for precision filtration constituted by members of a micro-porous filtration membrane, a membrane support, a core, an outer cover and end plates, all of the members being made of polyether sulfone represented by formula (I) or polysulfone represented by formula (II), wherein a reduced viscosity of pellets regenerated from the filter cartridge is not lower than 0.36 but lower than 0.45, or a melt flow rate of pellets regenerated from the filter cartridge is not lower than 5.0 and lower than 9; and a filtration method by use of the filter cartridge for precision filtration.

### FIELD OF THE INVENTION

The present invention relates to a filter cartridge using a micro-porous filtration membrane. More particularly, the present invention relates to a filter cartridge using a hydrophilic micro-porous precision filtration membrane which is excellent in resistance to chemicals and which has environmental suitability.

### BACKGROUND OF THE INVENTION

In recent years, a filter for filtration having high resistance to chemicals such as organic solvents, acids, alkalis and oxidizing agents and generating little eluent material been demanded in the manufacture of semiconductors. Currently, in filtration of such chemicals, a filter for filtration which uses a micro-porous precision filtration membrane using polytetrafluoroethylene (PTFE) as a raw material and which uses perfluoroalkoxy resin (PFA) for the other filter constituent members is used. However, in such a filter cartridge made from all fluoropolymer components, the hydrophobicity of the filtration membrane made of PTE is extremely high so that, even if the filtration membrane is moistened with alcohol such as isopropanol or the like at the beginning of filtration, air lock is caused by a small amount of included bubbles so as to block filtration. Thus, there is a problem that the filter cartridge made from all fluoropolymer components lacks filtration stability. In addition, when filtration of chemicals is started after the moistening treatment, a large quantity of the mixture liquid of the alcohol and the chemicals becomes waste. Further, the used filter cartridge cannot be melted to be recycled as pellets because foreign kinds of materials of PTFE and PFA are integrated therein by thermal adhesion (i.e., the thermal melting adhesion). In addition, there is a problem that toxic-gas is generated if the filter cartridge is incinerated. Due to such problems, a land-fill method is the only method to dispose of the filter cartridge made from all fluoropolyer components. However, a land-fill method causes another problem mainly in the environment.

However, in a filter cartridge in which all the constituent members described above are made of polyether sulfone, there still remains a problem as follows. That is, polyether sulfone has many kinds of grades different in molecular weight. The molecular weight grades used in the constituent members differ from one another. Thus, it was found that the fluidity of polyether sulfone melted was varied largely by a difference in molecular weight grade so as to cause a trouble in reuse of recycled pellets.

### SUMMARY OF THE INVENTION

In view of the conventional circumstances, an object of the present invention is to provide a filter cartridge for precision filtration which has, of course, excellent features in resistance to chemicals, filtration stability, and reduction in waste liquid, while the used filters can be recycled as pellets for reuse as injection-molded members of filters; and to provide a method for manufacturing the filter cartridge for precision filtration.

The foregoing object of the present invention is attained by the following paragraphs (1) to (6).

(1) A filter cartridge for precision filtration comprising members of a micro-porous filtration membrane, a membrane support, a core, an outer cover and end plates, all of the members being made of polyether sulfone represented by formula (I); wherein a reduced viscosity of pellets regenerated from the filter cartridge is not lower than 0.36 and lower than 0.45.

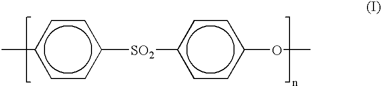

(2) A filter cartridge for precision filtration constituted by members of a micro-porous filtration membrane, a membrane support, a core, an outer cover and endplates, all of the members being made of polysulfone represented by formula (II); wherein a melt flow rate of pellets regenerated from the filter cartridge is not lower than 5.0 and lower than 9.0.

[chemical structure]

(3) The filter cartridge for precision filtration according to the paragraph (1), wherein at least one of the members is formed by hot melt molding, and then subjected to annealing treatment.

(4) The filter cartridge for precision filtration according to the paragraph (1), wherein the annealing treatment is carried out at a temperature of 140 to 200° C. for four hours or longer.

(5) The filter cartridge for precision filtration according to the paragraph (1), wherein the cartridge assembled is cleaned with a dilute acid and with hot ultra-pure water having a temperature from 50° C. to 100° C.

(6) A filtration method for semiconductor integrated circuit wafer cleaning fluid in a wafer cleaning process for manufacturing semiconductor integrated circuits, comprising the step of starting filtration of cleaning chemicals by use of a filter cartridge for precision filtration defined in the paragraph (2) without carrying out any preliminary hydrophilic treatment with alcohol.

### BRIEF DESCRIPTION OF THE DRAWING

FIG. 1 is a development view showing the structure of a general pleated filter cartridge.

### DETAILED DESCRIPTION OF THE INVENTION

Generally, as filter cartridges, there are known two types of cartridges, that is, a pleat cartridge having a structure in which a filtration membrane and membrane supports for protecting the filtration membrane are folded into a pleat-shape, and a flat-plate laminated cartridge in which a plurality of flat-plate type filtration units are laminated. The structure of the pleat cartridge is disclosed in JP-A-4-235722 (the term “JP-A” as used herein means an “examined published Japanese Patent application”), JP-A-10-66842, and so on, byway of example. The structure of the flat-plate laminated cartridge is disclosed in JP-A-63-80815, JP-A-56-129016, JP-A-58-98111, and so on, by way of example. The present invention is applicable to each of the two types of filter cartridges.

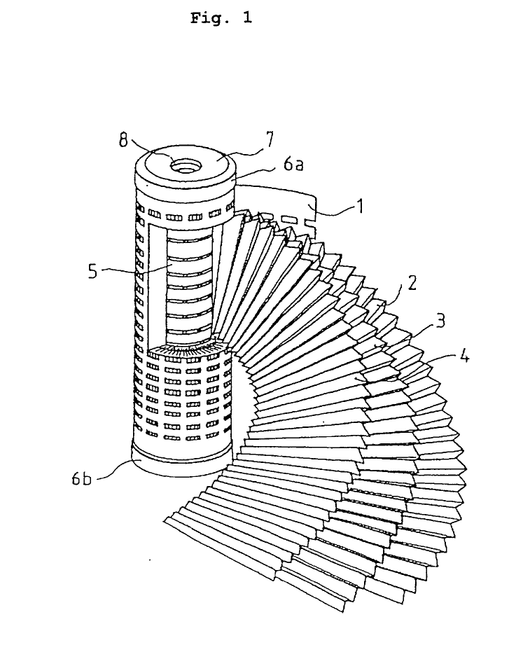

The structure of the pleat cartridge (i.e., the pleated filter cartridge) will be described below in detail by way of example. FIG. 1 is a development view showing the whole structure of a general pleated filter cartridge with a precision filtration membrane. A precision filtration membrane 3 is pleated while being sandwiched between two membrane supports 2 and 4, and wound around a core 5 having a large number of liquid collection ports. An outer cover 1 is disposed outside the precision filtration membrane 3 so as to protect the precision filtration membrane 3. At the both ends of the cylinder, the precision filtration membrane is sealed with end plates 6a and 6b. Each of the end plates abuts against a sealing portion of a filter housing (not shown) through a gasket 7. In some types, an O-ring is provided in one end plate portion so that the end plate portion abuts against the filter housing through the O-ring. The gasket or the O-ring can be easily removed when the filter is discarded. Filtered liquid is collected through the liquid collection ports of the core and discharged from a fluid outlet 8. There are two types, that is, one having two fluid outlets in both ends of a cylinder, and the other having one fluid outlet in one end while the other end is closed.

According to the present invention, polymer generally called polyether sulfone having a chemical structure shown in the following formula (I) is used for all members except for the gaskets and O-rings. It is conventionally known that polyether sulfone is high in heat resistance and excellent in resistance to chemicals. However, polyether sulfone is not resistant to particularly strongly oxidizing heated acid such as heated concentrated sulfuric acid or heated concentrated phosphoric acid used in the manufacture of semiconductors. Therefore, a filter made from all fluoropolymer components has been conventionally used in the semiconductor manufacturing process. The present inventor has found that polyether sulfone was resistant to filtration of chemicals for cleaning wafers for semiconductor integrated circuits, such as heated hydrochloric acid, heated ammonia, fluoric acid, and heated isopropanol. Thus, the present inventor has attained the present invention. Polyether sulfone is put on the market from Sumitomo Chemical Co., Ltd. by the name of Sumikaexcel PES.

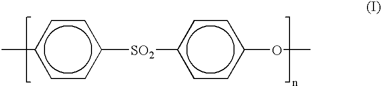

Sumikaexcel PES has various grades in accordance with a difference in average molecular weight. The respective grades are given by product numbers in accordance with their own average reduced viscosity, for example, 3600G (a reduced viscosity: 0.36), 4100G (a reduced viscosity: 0.41), 4800G (a reduced viscosity: 0.48), 5200G (a reduced viscosity: 0.52), and so on. The reduced viscosity is calculated from the dimethylformamide solution viscosity (measuring temperature: 25° C.) of 1 (w/v) % polyether sulfone, and used as a standard for the molecular weight. With the increase in a reduced viscosity, polyether sulfone has larger molecular weight so that the polyether sulfone melt is lower in fluidity but becomes greater in strength.

Polyether sulfone having a high molecular weight and hence a high reduced viscosity of not lower than 0.48 is generally used for the precision filtration membrane 3. Particularly, polyether sulfone having a high reduced viscosity of not lower than 0.50 is regarded as preferable. When a micro-porous filtration membrane is produced, coarse pores called finger type pores are apt to be formed in polyether sulfone having low viscosity. It is therefore difficult to control the pore size. In the worst case, the membrane cannot be used for filtration because pin-holes are produced. Polyether sulfone to be used is regarded as better if the reduced viscosity thereof is higher. However, a micro-porous filtration membrane producing no finger type pore can be formed even out of polyether sulfone having a middle reduced viscosity if a high-viscosity solvent is selectively used to prepare a solution for forming the membrane, or if additives for increasing the viscosity are selectively combined. Thus, the reduced viscosity of polyether sulfone suitable for a precision filtration membrane according to the present invention is in a range of from 0.41 to 0.50, preferably from 0.41 to 0.45. Example 1 shows an example to produce a precision filtration membrane using polyether sulfone with a low reduced viscosity. Methods for producing a hydrophilic micro-porous precision filtration membrane using polyether sulfone as a material are disclosed in detail in JP-A-56-154051, JP-A-56-86941, JP-A-56-12640, JP-A-62-27006, JP-A-62-258707, and JP-A-63-141610.

The pore size of the filtration membrane is usually in a range of from 0.02 μm to 5 μm. In applications for manufacturing semiconductors, the pore size is preferably in a range of from 0.02 μm to 0.45 μm. Particularly for manufacturing high-integrated ICs, the indication pore size is preferably in a range of from 0.02 μm to 0.2 μm. The characteristic of such a membrane can be represented by 0.3 MPa or more in the water bubble point measured in the method of ASTM F316, and by 0.1 to 1 MPa in ethanol bubble point likewise. Particularly, it is preferable that the characteristic is in a range of from 0.3 MPa to 0.7 MPa in ethanol bubble point. It is preferable that the ratio of pores to the apparent volume of the membrane is higher because the filtration resistance becomes lower. On the other hand, if there are too many pores, the strength of the membrane is lowered so that the membrane is easily broken. Conventionally, it has been therefore regarded as preferable that the porosity of the filtration membrane is in a range of from 40% to 90%, more preferably from 57% to 85%. If the membrane is too thick, the membrane area which can be incorporated in a cartridge is reduced. On the other hand, if the membrane is too thin, the strength of the membrane is lowered. It has been therefore regarded as preferable that the membrane thickness is in a range of from 80 μm to 160 μm. The membrane according to the present invention is also used to satisfy such conventionally preferable ranges. However, in order to recycle the used filters as pellets, it is preferable that the quantity of use of polyether sulfone with a high reduced viscosity is reduced. Therefore, the porosity of the membrane according to the present invention is preferably in a range of from 75% to 85%, and the thickness thereof is preferably in a range of from 80 μm to 120 μm. Example 2 shows an example to use high-reduced-viscosity polyether sulfone for a precision filtration membrane material so as to increase the porosity and reduce the membrane thickness.

The precision filtration membrane 3 is sandwiched between the membrane supports 2 and 4 and pleated in a usually known method. Non-woven fabric, woven fabric, net, or the like, is used as the membrane supports 2 and 4. The membrane supports play not only the role of reinforcing the filtration membrane against filtration pressure fluctuation, but also the role of introducing liquid deeply into the pleats. Therefore, the membrane supports must have a moderate liquid permeability and sufficiently higher physical strength than that of the filtration membrane. Any sheet material may be used if it has such functions. To be used in the present invention, the membrane supports must be formed out of a material which has resistance to heat and resistance to chemicals as well as the above-described general functions, and which is comparatively inexpensive. Therefore, available raw materials are limited. In addition, in order to attain one of the objects of the present invention, that is, in order to recycle and reuse the used filter cartridges as pellets, the material of the membrane supports preferably is polyether sulfone. It is preferable that the thickness of each membrane support is in a range of from 50 μm to 60 μm when the thickness is measured with a screw micrometer. It has been conventionally regarded as preferable that the weight (i.e., the basis weight) is in a range of from 20 g/m² to 100 g/m² in non-woven fabric or woven fabric. This is because strength is insufficient if the fabric is too thin, while the required area of a filtration membrane accommodable in the cartridge cannot be ensured if the fabric is too thick. Also in the present invention, each of the membrane supports is used in such preferable ranges. However, in order to recycle the used filters as pellets, it is more preferable that the thickness is in a range of 80 μm to 180 μm, and the weight (i.e., the basis weight) is in a range of from 20 g/m² to 35 g/m² when polyether sulfone having a lower reduced viscosity grade than that of polyether sulfone used for the core, the outer cover or the end plate is used.

The net can be obtained by spinning a mono-filament having a diameter in a range of from 50 μm to 300 μm, and weaving the spun mono-filament. The mono-filament used for the net is thicker and stronger than yarn for non-woven fabric. Therefore, the mono-filament can be spun easily. The thinner the mono-filament is, the thinner the finished net is, hence the more easily the net can be pleated. On the other hand, if the mono-filament is thin, it becomes difficult to spin. In addition, the strength of the finished net is also lowered. Accordingly, it has been conventionally regarded as preferable that the filament size is in a range of from 60 μm to 200 μm. Particularly, in the present invention, the filament size is preferably in a range of from 60 μm to 100 μm. When the mesh size is too large, the net is easily deformed with a small force so that it becomes difficult to pleat the net. On the contrary, if the mesh size is small, the liquid permeability deteriorates so that the flow rate of a completed filter cartridge is reduced. Accordingly, it has been conventionally regarded as preferable that the mesh size is in a range of from 50 meshes to 300 meshes. Particularly, in the present invention, it is preferable that the mesh size is in a range of from 50 meshes to 120 meshes because the weight can be reduced. The reduced viscosity of polyether sulfone used for non-woven fabric or net is preferably lower than 0.45. Low-viscosity polyether sulfone is so high in fluidity that there is also an advantage that the productivity is excellent. When non-woven fabric or net is used for the support material in the present invention, it is especially preferable that polyether sulfone having a reduced viscosity grade as high as that of polyether sulfone used for the core, the outer cover or the end plate is used.

The irregular both end portions of the pleated filtration material are cut off with a cutter knife or the like, so as to be trued up. The filtration material is then rounded into a cylindrical shape, and the pleats in the joint portions of the both end portions are liquid-tightly sealed with a heat seal or a bonding agent. The adhesion sealing may be carried out on a total of 6 layers of precision filtration membranes and membrane supports together. Alternatively, the adhesion sealing may be carried out so that filtration membranes in the absence of membrane supports 2 and 4 are put on top of each other directly. Heat seal may be carried out by sandwiching a thermoplastic sheet between the pleats so as to bond one pleat with another. Polyether sulfone is also used as the bonding agent or the thermoplastic sheet used herein. As the bonding agent, for example, 10 parts of polyether sulfone is dissolved a mixed solution of 30 parts of methylene chloride and 20 parts of diethylene glycol, and 140 parts of diethylene glycol is added and mixed thereto gradually. The solvent is heated and volatilized after adhesion, so as to be not left in the filter cartridge.

The core 5 is inserted into the cylindrical filtration material formed thus, and covered with the outer cover 1. The body formed thus is called a pleated body. An end seal process for liquid-tightly bonding and sealing the both end portions of the pleated body with the end plates 6 is roughly classified into a method based on hot melt and a method based on solvent bonding. In the hot melt method, only the seal surface of the end plate is brought into contact with a hot plate or irradiated with infrared rays by an infrared heater so that only the surface is heated and melt. One end surface of the pleated body is pressed onto the melt surface of the end plate so as to be bonded and sealed.

In the solvent bonding method, it is important to select a solvent. A solvent having no or low dissolubility for the filtration membrane but having dissolubility for the end plate is usually selected. The solvent may be a chemical species alone or may be a mixture of solvents. When two or more kinds of solvents are mixed, a solvent having no dissolubility for the filtration membrane is selected at least as one kind of solvent higher in boiling point. It is more preferable that about 1% to 7% of polyether sulfone is dissolved in the solvent bonding agent in advance.

The material used for the core 5, the outer cover 1 and the end plates 6 must also have resistance to heat and resistance to chemicals, and must be a material capable of being recycled as pellets. Therefore, polyether sulfone is used. It is preferable that all the materials are unified to polyether sulfone, because the range of the resistance to chemicals is expanded and the adhesion sealing property is improved. As the end plates, inject-molded ones are mainly used from the view point of productivity. Generally, polyether sulfone having low reduced viscosity or middle reduced viscosity and hence having high fluidity is preferably used in injection molding from the point of view of productivity. Accordingly, it is preferable that the reduced viscosity is in a range of from 0.36 to 0.45. If polyether sulfone having high viscosity is injection-molded, strain is left in a molded product. Thus, when the molded product comes in contact with chemicals, the strain causes cracks easily. On the contrary, polyether sulfone having a low viscosity of lower than 0.36 is easily eroded by a strong acid having strong oxidizing power. Thus, there is a problem that such low-viscosity polyether sulfone is degraded rapidly. Accordingly, it is ideal that polyether sulfone having a reduced viscosity ranging from 0.41 to 0.45 can be used for all the constituent materials.

If the above-described ideal can not be fulfilled it is preferable that the ratio of the total weight of the core, the outer cover and the end plates to the weight of the whole of the filter cartridge except for the gaskets and the O-rings is not lower than 80%. As the ratio of the total weight of the core, the outer cover and the end plates formed by injection molding increases, the reduced viscosity of pellets regenerated from the used filter cartridges becomes equal to or close to the reduced viscosity of the raw material of the injection-molded members. Thus, the pellets can be used for molding the core, the outer cover and the end plates again. If the reduced viscosity of polyether sulfone used for the precision filtration membrane is not lower than 0.45, the ratio of the weight of the precision filtration membrane to the weight of the filter cartridge must be set to be not higher than 10%. Preferably, the ratio is suppressed to be not larger than 7.5%.

When the end plate formed by hot melt molding comes in contact with an organic solvent, very small cracks are easily produced in the end plate due to residual strain generated during the hot melt molding. Particularly when weld sealing is carried out with a solvent bonding agent, cracks may be produced violently. On occasion, small cracks may be produced even with hot melt sealing. Accordingly, it is preferable that thermal strain is eliminated from the end plate by annealing before weld sealing with a solvent bonding agent. If annealing is not carried out before sealing with a solvent bonding agent, very small cracks are produced easily. Therefore, preferably, annealing is carried out before sealing. When residual strain is comparatively low in the endplate and hot melt sealing is adopted, the end plate is rarely cracked even without annealing before weld sealing. However, in the case of hot melt sealing, water absorbed on the end plate is bubbled due to heat so that a large number of small bubbles are produced on the surface and in the inside on the end plate. In the worst case, a gap is produced between the filtration membrane and the end plate, resulting in leakage of particles at the time of filtration. If annealing is not carried out at all in the process for manufacturing the filter cartridge, very small cracks are produced in the end plate when high-temperature isopropanol filtration is carried out. Thus, liquid leaks through the cracks.

The conditions of annealing is described below.

The annealing temperature is preferably in a range of from 140° C. to 200° C., and more preferably in a range of from 160° C. to 180° C. Although the treatment time varies in accordance with the annealing time, it requires two hours or longer, preferably four hours or longer. It is perfect and especially preferable to carry out annealing for five hours or longer at 180° C.

Not to say, it is not essential but preferable to carry out annealing on hot melt molded members excluding the end plates in the same manner as the end plates.

The regenerated polyether sulfone pellets may be mixed into the respective members of the filter cartridge. Preferred members to be mixed with the pellets include the core, the outer cover, the end plates, and the net. Especially, the core and the outer cover are preferably mixed with the pellets. At that time, the mixing rate of non-regenerated polyether sulfone is from 10% to 80%, preferably from 30% to 60%. In addition, the mixing rate of non-regenerated polyether sulfone to the total weight of the filter cartridge is from 20% to 90%, preferably from 40% to 70%.

Even if such regenerated polyether sulfone was used, there was no large change in molding property, and the physical property or the strength of each molded member formed thus had little change.

All the members may be formed out of Udel polysulfone on sale at Amoco Polymers, Inc., and represented by formula (II), in place of polyether sulfone of the present invention.

[chemical structure]

When Udel polysulfone is used, it is preferable that the MFR (Melt Flow Rate) value of pellets recycled as a cartridge is in a range of from 5.0 to 9.0.

Udel polysulfone has two kinds of grades in accordance with a difference in average molecular weight. The respective grades are given product numbers P-1700 (MFR value ranging from 5 to 9) and P-3500 (MER value ranging from 2 to 4.9) in accordance with their own average MER values. The MFR values are measured according to the standard test method ASTMD 1238 set up by American Society for Testing and Materials. The MFR values indicate fluidity of polysulfone melt and are used as the basis for grade selection at the time of hot melt molding. The MFR values do not always have one to one correspondence to molecular weights. Generally, however, the larger the MFR value is, the smaller the molecular weight is. Thus, the fluidity of the melt becomes so high that the productivity of hot molding is improved. On the contrary, the smaller the MFR value is, the larger the molecular weight is. Thus, the fluidity of the melt becomes low but the strength is increased. The measured MFR values of polysulfone are values expressing, in gram unit, the weight of the melt extruded from a cylinder for 10 minutes under the conditions of the temperature 343° C. and the pressure 0.3 Mpa.

Polysulfone having a high molecular weight, that is, a low MFR value of not higher than 5, is generally used for the precision filtration membrane 3. Coarse pores called a finger type are easily formed in Polysulfone small in molecular weight when a micro-porous filtration membrane is manufactured. It is therefore difficult to control the pore size. In the worst case, pin-holes are produced so that the membrane cannot be used for filtration. It has been regarded as better that the MFR value of polysulfone used is smaller. However, a micro-porous filtration membrane producing no finger type pore can be formed even out of polysulfone having a middle MFR value if a high-viscosity solvent is selectively used to prepare a solution for forming the membrane, or if additives for increasing the viscosity are selectively combined. In order to recycle and reuse the used filters as pellets, polysulfone having a high MFR value ranging from 3.5 to 9 is used instead for a precision filtration membrane according to the present invention. Especially, the MFR value is preferably in a range of from 4.9 to 7.

A filter cartridge produced thus must be cleaned in order to perfectly eliminate a very small amount of metal ions of sodium and calcium or organic matters contained as impurities in polysulfone polymer, and metal fine powder or organic matter contaminations adhering to the filter cartridge in the step of assembling the filter cartridge. As a result of diligent researches, the present inventors found an inexpensive, efficient and effective method for cleaning the metal ions and the organic matter contaminations. The method will be described below in detail.

Dilute acid dipping is first carried out as follows. That is, a plurality of filter cartridges are put into a net basket, and dipped into liquid filled with a dilute acid together with the net basket. Thus, the filter cartridges are treated for at least from about two hours to about ten hours while vibration is given to the filter cartridges. The vibration may be given in any method if it does not impair the perfectibility of the filter cartridges. Such methods include a method of stirring the liquid; a method of moving the basket vertically or horizontally; a method of providing ultrasonic vibration; a method of once lifting the basket above the liquid surface to thereby drain the liquid from the basket, and then dipping the basket into the liquid again; and soon. Since the perfectibility of the filter cartridges is impaired if an intensive ultrasonic wave is imparted thereto for 10 or more minutes, the intensity of the ultrasonic wave has to be determined in thorough consideration. Not to say, the treatment time and the method and degree of the vibration depend on the degree of contamination on the filter cartridges. Necessary and sufficient conditions have to be chosen by measuring the cleaning effect.

Preferable acids to be used include hydrogen halides such as hydrochloric acid and bromic acid, organic carboxylic acids such as acetic acid and oxalic acid, nitric acid, and sulfuric acid. It is more preferable to use hydrogen halides which are difficult to be residual in the filters after cleaning with super-pure water or after drying after the cleaning. Especially, of the hydrogen halides, general hydrochloric acid is particularly preferred. It is preferable to use a dilute acid with a concentration ranging from 0.1 (mol/L) to 5 (mol/L). If the concentration of the acid is too dilute, the cleaning power deteriorates. On the contrary, if the acid is too concentrated, rinsing with super-pure water in the subsequent step becomes a big burden unnecessarily and inefficiently. Particularly, it is preferable to use acid having a concentration ranging from 0.5 N (mol/L) to 2 N (mol/L). The acid having a high liquid temperature is effective. However, this may bring a risk that an equipment is eroded easily and contaminations caused by the erosion of the equipment may adhere to the filter cartridges. In addition, hydrogen halide gas is easily produced at a high temperature. Thus, environmental management becomes difficult. It is therefore preferable that the liquid temperature is in a range of from 20° C. to 40° C. If the filter cartridges are contaminated conspicuously, it is preferable to replace the dilute acid liquid with fresh one in the middle of the treatment.

When cleaning with acid for predetermined time is completed, the filter cartridges are lifted above the liquid surface together with the basket, and left for several minutes so as to drain the liquid from the filter cartridges. Succeedingly, the filter cartridges together with the basket are dipped into a super-pure water tank, and vibration is given thereto. The given vibration is similar to that in the previous step. It is preferable to set the temperature of the super-pure water to be the same as that in the previous step. After dipped in the super-pure water for 5 minutes to 20 minutes, the filter cartridges are lifted up together with the basket. The super-pure water in the tank is replaced by fresh one. Then, the filter cartridges are dipped into the fresh super-pure water again. Such dipping with super-pure water is repeated two to four times. The acid concentration is lowered by the rinsing so that there is no fear that the equipment is eroded. It is therefore preferable that the temperature of super-pure water in which the filter cartridges are dipped for the last time is set to be a high temperature of from 40° C. to 80° C.

Next, the filter cartridges are set in filter housings one by one. Cleaning is continued while super-pure water permeates and is filtered through the filter cartridges. It is preferable that the liquid outlet of the filter cartridge is directed toward the upper portion. If so, rinsing water permeates all over the upper and lower portions of the filter cartridge at substantially the same flow rate. This water permeation is continued till the specific resistance value of super-pure water permeating the filter cartridge reaches the same level as the theoretical level of raw water. Here, in order to carry out cleaning efficiently, hot super-pure water is used in the initial stage of the water permeation. The flow rate of water permeating each 10-inch filter cartridge is preferably in a range of from 2 liters to 10 liters per minute. It is not efficient to carry out the water permeation at a flow rate of more than 10 liters per minute. The flow rate of more than 10 liters does not improve the cleaning effect at all, but just increases cost for the hot super-pure water in vain. The temperature of the hot water is set to be not lower than 50° C. The higher the water temperature is, the higher the cleaning effect is. However, if the water temperature is more than 10° C., boiling control becomes difficult unpreferably. The temperature is preferably in a range of from 50° C. to 100° C., and a temperature around 85° C is the temperature to be effective and handled most easily. Hot water usually permeates for 30 minutes to 60 minutes, and then replaced by cold super-pure water. The cold super-pure water continuously permeates at a flow rate of 5 liters to 10 liters per minute till the specific resistance value of the water filtered reaches the theoretical level of the super-pure water. This water permeation can be usually completed in 10 minutes to 30 minutes.

A filter cartridge produced thus is attached to a filter housing incorporated in a cleaning apparatus under clean environment in a semiconductor manufacturing factory. While chemicals are sent gradually to the filter housing by a pump, the filter housing is evacuated of the air on its primary side. When the chemicals begin to leak from an air evacuation port, the air evacuation port is closed, and filtration of the chemicals is started. At first, recirculation filtration is carried out for a while so that the chemicals filtered is sent back to a chemicals supply tank. Thus, dust mixed by mistake is captured by the filter so that the system is cleaned up. After that, a wafer is cleaned normally. Before the chemicals permeate, super-pure water may permeate for a while to thereby clean the system. In this case, when filtration of the chemicals is started, it is necessary to dispose 0.5 liters to 2 liters of an initial flow thereof as waste liquid. Preferably, the chemicals permeate from the beginning as described in the former case.

When filtration is continued for a long term, the air may be collected on the primary side of the filter housing for the long term. In such a case, the air evacuation port is opened slightly so as to eliminate the air. In the case of a polyether sulfone filter, even if the air is collected to some extent, there is no fear that the collected air makes the filtration membrane too hydrophobic to filter the cleaning chemicals, unlike the case for a PTFE filter. Accordingly, it is not necessary to remoisten the filtration membrane with alcohol in the middle of use. Thus, there is no fear that additional waste liquid is produced.

To exchange the filter on a regular schedule, all the chemicals in the system of the cleaning apparatus including the filter housing are discharged from the liquid discharge port. After that, super-pure water permeates the filter cartridge so as to wash away residual cleaning liquid left in the filter cartridge. Then, the filter cartridge is extracted from the housing under clean environment. Such extracted filter cartridges are drained of the water, and then collected. O-rings and gaskets are removed from the filter cartridges. The filter cartridges are dried, then melted and regenated as pellets. The pellets can be reused as fuel.

### EXAMPLE

The present invention will be described below in more detail in accordance with examples. The present invention is however not limited to these examples.

### Example 1

A membrane forming solution was prepared out with 14 parts of polyether sulfone (Sumikaexcel PES 4100G made by Sumitomo Chemical Co., Ltd.; a reduced viscosity: 0.41), 24 parts of polyvinylpyrrolidone (K-30 made by Wako Pure Chemical Industries, Ltd.), 20 parts of polyethylene glycol 400 (made by Wako Pure Chemical Industries, Ltd.), 40 parts of N-methyl-2-pyrrolidone, and 7 parts of water. This solution was cast into a flat membrane. The flat membrane was brought into contact with the air having a dew point of 20° C. for 8 seconds, and then dipped into water at 4° C. Thus, a micro-porous filtration membrane was formed. The formed membrane had an ethanol bubble point of 350 kPa, a membrane thickness of 140 μm, and a porosity of 80%. This membrane was sandwiched between a pair of 60-mesh nets having a filament diameter of 100 μm, and folded into pleats. The pleat interval was 12 mm, and the membrane width was 230 mm. The membrane was cut off at the 200th mountain, and the both ends of the membrane were laid on each other and heat-sealed to form a hollow cylinder. A core was inserted into this hollow portion, and the cylinder was covered with an outer cover. Thus, a pleated body was formed. Polyether sulfone used for the nets was Sumikaexcel 4100G (a reduced viscosity: 0.41) made by Sumitomo Chemical Co., Ltd.

The surface of end plates was irradiated with infrared rays by an infrared heater. Thus, the surface of the end plate was heated to about 350° C. so as to be melted. An end portion of the pleated body preheated sufficiently was pressed against the melted surface of the end plate so as to be bonded and sealed thereto. Another end plate was welded and sealed to the other side of the pleated body in the same manner. Thus, a filter cartridge was completed. The outer cover, the core and the end plates were formed by injection molding using Sumikaexcel 4100G (a reduced viscosity: 0.41). The end plates and the pleated body were annealed at 180° C. for five hours immediately before they were welded and sealed to each other. After the perfectibility was measured, the filter cartridge completed was dipped in 5% hydrochloric acid for four hours, and next dipped into super-pure water. Further, the filter cartridge was mounted into a filter housing. The filter cartridge was permeated with a hot water of 80° C. for 20 minutes, and the filter cartridge was permeated with super-pure water so as to eliminate the hydrochloric acid. The filter cartridge was drained of the water, and then dried at 65° C. for twelve hours by a clean oven.

The filter cartridge produced thus was melted to form recycled pellets. When the a reduced viscosity of the pellets was measured, it was 0.38. Therefore, the pellets could be reused as a raw material for injection-molded members such as the core, the outer cover, and so on.

### Example 2

A membrane forming solution was prepared out with 14 parts of polyether sulfone (Sumikaexcel PES 4800G made by Sumitomo Chemical Co., Ltd.; a reduced viscosity: 0.48), 16 parts of polyvinylpyrrolidone (K-30 made by Wako Pure Chemical Industries, Ltd.), 63 parts of N-methyl-2-pyrrolidone, and 7 parts of water. This solution was cast into a flat membrane. The flat membrane was brought into contact with the air having a dew point of 20° C. for 8 seconds, and then dipped into water at 4° C. Thus, a micro-porous filtration membrane was formed. The formed membrane had an ethanol bubble point of 350 kPa, a membrane thickness of 110 μm, and a porosity of 82%. This membrane was sandwiched between a pair of 60-mesh nets having a filament diameter of 100 μm, and folded into pleats. The pleat interval was 10.5 mm, and the membrane width was 210 mm. The membrane was cut off at the 200th mountain, and the both ends of the membrane were laid on each other and heat-sealed to form a hollow cylinder. A core was inserted into this hollow portion, and the cylinder was covered with an outer cover. Thus, a pleated body was formed. Polyether sulfone used for the nets was Sumikaexcel 4100G (a reduced viscosity: 0.41) made by Sumitomo Chemical Co., Ltd.

The surface of end plates was irradiated with infrared rays by an infrared heater. Thus, the surface of the end plate was heated to about 350° C. so as to be melted. An end portion of the pleated body preheated sufficiently was pressed against the melted surface of the end plate so as to be bonded and sealed thereto. Another end plate was welded and sealed to the other side of the pleated body in the same manner. Thus, a filter cartridge was completed. The outer cover, the core and the end plates were formed by injection molding out of Sumikaexcel 4100G (a reduced viscosity: 0.41). The end plates and the pleated body were annealed at 180° C. for five hours immediately before they were welded and sealed to each other. After the perfectibility was measured, the filter cartridge completed was dipped in 5% hydrochloric acid for four hours, and next dipped into super-pure water. Further, the filter cartridge was mounted into a filter housing. The filter cartridge was permeated with a hot water of 80° C. for 20 minutes, and super-pure water permeated the filter cartridge so as to eliminate the hydrochloric acid. The filter cartridge was drained of the water, and then dried at 65° C. for twelve hours by a clean oven.

The filter cartridge produced thus was melted to form recycled pellets. When the a reduced viscosity of the pellets was measured, it was 0.40. Therefore, the pellets could be reused as a raw material for injection-molded members such as the core, the outer cover, and so on. The weight of the membrane used was 22 g, the weight of the nets was 48 g, and the total weight of the other molded members was 288 g.

When a filter cartridge for precision filtration according to the present invention is used for filtration of chemicals for cleaning wafers in a semiconductor manufacturing process, initial waste liquid is hardly produced, end plates are not cracked in use, and the used filter cartridge can be recycled and reused as pellets.

The entitle disclosure of each and every foreign patent application from which the benefit of foreign priority has been claimed in the present application is incorporated herein by reference, as if fully set forth herein.

While the invention has been described in detail and with reference to specific embodiments thereof, it will be apparent to one skilled in the art that various changes and modifications can be made therein without departing from the spirit and scope thereof.

What is claimed is:

1. A filter cartridge for precision filtration comprising members of a micro-porous filtration membrane, a membrane support, a core, an outer cover and end plates, all of said members being made of polyether sulfone represented by formula (I): 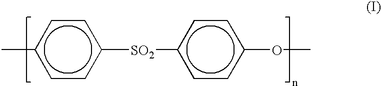
wherein a reduced viscosity of pellets regenerated from said filter cartridge is not lower than 0.36 and lower than 0.45.

2. A filter cartridge for precision filtration comprising members of a micro-porous filtration membrane, a membrane support, a core, an outer cover and end plates, all of said members being made of polysulfone represented by formula (II): [chemical structure]
wherein a melt flow rate of pellets regenerated from said filter cartridge is not lower than 5.0 and lower than 9.0.

3. The filter cartridge for precision filtration as in claim 1, wherein at least one of said members is formed by hot melt molding, and then subjected to annealing treatment.

4. The filter cartridge for precision filtration as in claim 1, wherein said annealing treatment is carried out at a temperature of 140 to 200° C. for four hours or longer.

5. The filter cartridge for precision filtration as in claim 1, wherein said cartridge assembled is cleaned with a dilute acid and with hot ultra-pure water having a temperature of from 50° C. to 100° C.

6. A filtration method for semiconductor integrated circuit wafer cleaning fluid in a wafer cleaning process for manufacturing semiconductor integrated circuits, comprising the step of starting filtration of cleaning chemicals by use of a filter cartridge for precision filtration comprising members of a micro-porous filtration membrane, a membrane support, a core, an outer cover and end plates, all of said members being made of polysulfone represented by formula (II): [chemical structure]
wherein a melt flow rate of pellets regenerated from said filter cartridge is not lower than 5.0 and lower than 9.0; without carrying out any preliminary hydrophilic treatment with alcohol.
